(19) United States
(12) Patent Application Publication
(10) Pub. No.: US 2025/0279666 A1
(43) Pub. Date: Sep. 4, 2025

(54) FUEL CELL SYSTEM

(71) Applicant: TOYOTA JIDOSHA KABUSHIKI KAISHA, Toyota-shi (JP)

(72) Inventor: Takuya IKEDA, Toyota-shi (JP)

(73) Assignee: TOYOTA JIDOSHA KABUSHIKI KAISHA, Toyota-shi (JP)

(21) Appl. No.: 19/014,267

(22) Filed: Jan. 9, 2025

(30) Foreign Application Priority Data
Mar. 1, 2024 (JP) 2024-031513

(51) Int. Cl. H02J 7/00; H02J 7/34

(52) U.S. Cl. CPC H02J 7/007182; H02J 7/0048; H02J 7/342

(57) ABSTRACT

The fuel cell system includes a fuel cell stack in which a plurality of fuel cells is stacked and arranged, a battery electrically connected to the fuel cell stack and charging electric power generated by the fuel cell stack, and a control device that controls power generation by the fuel cell stack. The control device is configured to execute a low-voltage operation prior to transition to a normal operation, when the fuel cell system is activated. In the low-voltage operation, the power generation by the fuel cell stack is controlled so that the output voltage of the fuel cell is maintained at or below the first voltage value, and in the normal operation, the power generation by the fuel cell stack is controlled so that the output voltage of the fuel cell is maintained at or above the second voltage value higher than the first voltage value.

### CROSS-REFERENCE TO RELATED APPLICATION

This application claims priority to Japanese Patent Application No. 2024-031513 filed on Mar. 1, 2024, incorporated herein by reference in its entirety.

### BACKGROUND

### 1. Technical Field

The technology disclosed in the present specification relates to a fuel cell system including a plurality of fuel cells.

### 2. Description of Related Art

Japanese Unexamined Patent Application Publication No. 2007-287674 (JP 2007-287674 A) describes a fuel cell system. The fuel cell system includes a fuel cell stack that includes a plurality of fuel cells, and a control device that controls power generation by the fuel cell stack. The control device is configured to be capable of executing a voltage control operation when the fuel cell system is activated. In the voltage control operation, following output voltage of the fuel cells being increased to a first voltage value following activation, control is performed such that the first voltage value is maintained for a predetermined amount of time.

### SUMMARY

A fuel cell generally has a current-voltage characteristic (so-called IV characteristic) in which the greater the output current becomes, the lower the output voltage becomes. Accordingly, when power is generated by the fuel cell stack, power generation efficiency of the fuel cell can be improved by suppressing the output current and increasing the output voltage of the fuel cell (hereinafter, also referred to as “cell voltage”). On the other hand, the higher the cell voltage at the time of power generation becomes, elution and coarsening of a catalyst (e.g., platinum-based fine particles) contained in the fuel cell occurs readily, which promotes deterioration of the catalyst.

In view of the above, the present specification provides a novel and useful technology for suppressing deterioration of a catalyst in a fuel cell.

The technology disclosed in the present specification is embodied in a fuel cell system.
This fuel cell system includes
a fuel cell stack in which a plurality of fuel cells is disposed, being stacked,
a battery that is electrically connected to the fuel cell stack and that performs charging of power generated by the fuel cell stack, and
a control device for controlling power generation by the fuel cell stack.
The control device is configured to execute a low-voltage operation prior to transition to a normal operation, when the fuel cell system is activated.
In the low-voltage operation, power generation by the fuel cell stack is controlled such that output voltage of the fuel cells is maintained at no higher than a first voltage value, and
in the normal operation, power generation by the fuel cell stack is controlled such that the output voltage of the fuel cells is maintained at no lower than a second voltage value that is higher than the first voltage value.

In the above configuration, at the time of activating the fuel cell system, the low-voltage operation can be executed prior to the normal operation being activated. In the low-voltage operation, power generation is performed by the fuel cell stack while the output voltage (cell voltage) of the fuel cells is maintained at a lower level than in the normal operation. As a result, in each of the fuel cells, an oxide film is formed on the surface of the catalyst. Thus, even when the output voltage of the fuel cells is maintained at a high level in the subsequent normal operation, elution and coarsening of the catalyst are suppressed by the oxide film formed on the surface of the catalyst. That is to say, deterioration of the catalyst is suppressed.

In an embodiment of the present technology, when the fuel cell system is activated and a charging rate of the battery exceeds a first charging rate, the control device may skip execution of the low-voltage operation. In low-voltage operation, the cell voltage is maintained at a relatively low level, and accordingly the current output from the fuel cell stack is relatively great. Therefore, when the charging rate of the battery is relatively high, execution of the low-voltage operation may be skipped, thereby circumventing a situation such as overcharging of the battery.

In an embodiment of the present technology,
the low-voltage operation may include
a first low-voltage operation in which power generation by the fuel cell stack is controlled such that the output voltage of the fuel cells is maintained at no higher than a third voltage value that is lower than the first voltage value, and
a second low-voltage operation in which power generation by the fuel cell stack is controlled such that the output voltage of the fuel cells is maintained between the third voltage value and the first voltage value.

According to the above configuration, in the low-voltage operation, the cell voltage can be changed in at least two stages. In particular, in an earlier stage of the low-voltage operation, generation of the oxide film can be promoted by maintaining the cell voltage even lower. Then in a later stage of the low-voltage operation, increasing the cell voltage enables further growth of the oxide film while suppressing the power that is generated by the fuel cell stack. Also, the cell voltage is increased and the power that is generated by the fuel cell stack is reduced, and accordingly the load on the battery can also be reduced.

In an embodiment of the present technology,
when the fuel cell system is activated, the control device may
execute the first low-voltage operation and the second low-voltage operation in that order when the charging rate of the battery is lower than a second charging rate that is lower than the first charging rate, and
skip execution of the first low-voltage operation and execute the second low-voltage operation when the charging rate of the battery is between the second charging rate and the first charging rate.

According to the above configuration, executing both the first and second low-voltage operations, and executing only the second low-voltage operation, are available in accordance with the charging rate of the battery. That is to say, the low-voltage operation can be executed in an appropriate form in accordance with the charging rate of the battery.

In an embodiment of the present technology, when the charging rate of the battery reaches the first charging rate after starting of the first low-voltage operation, the control device may transition to the second low-voltage operation. According to such a configuration, the low-voltage operation can be executed in an appropriate form in accordance with the charging rate of the battery, while suppressing the battery from becoming overcharged.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a configuration of a fuel cell system 2;

FIG. 2 is a flowchart showing a series of processes executed by the control device 30 in the fuel cell system 2 according to the first embodiment;

FIG. 3 is a graph showing a change over time in the output voltage of the fuel cell 12 in the fuel cell system 2 according to the first embodiment; and also shows a process of forming an oxide film (PtO) on the catalyst (Pt);

FIG. 4 is a flowchart showing a series of processes executed by the control device 30 in the fuel cell system 2 according to the second embodiment;

FIG. 5 is a graph illustrating a change in the output-voltage of the fuel cell 12 with time in the fuel cell system 2 according to the second embodiment; and showing a process in which an oxide film (PtO) is formed on the catalyst (Pt); and

FIG. 6 is a flowchart showing a series of processes executed by the control device 30 in the fuel cell system 2 according to the third embodiment.

### DETAILED DESCRIPTION OF EMBODIMENTS

### Example 1

The fuel cell system 2 of the first embodiment will be described with reference to the drawings. As an example, the fuel cell system 2 of the first embodiment can be employed in a fuel cell electrified vehicle (FCEV: Fuel Cell Electric Vehicle). Further, the configuration described in this embodiment is not limited to electrified vehicle, and can be similarly adopted as a power source for other types of devices and facilities that require power.

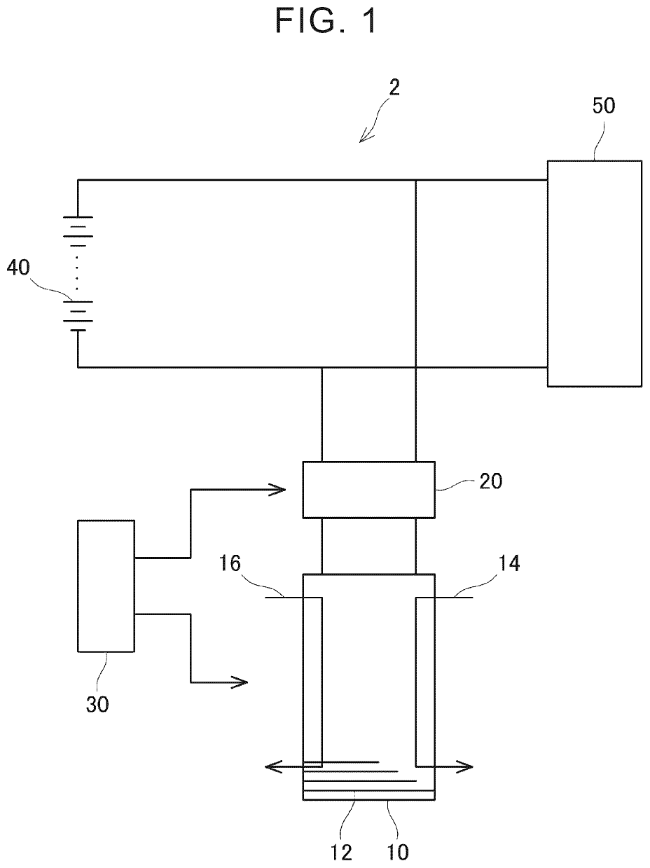

As illustrated in FIG. 1, the fuel cell system 2 includes a fuel cell stack 10, a step-up converter 20, a control device 30, a battery 40, and an electric load 50. The fuel cell stack 10 is configured by stacking a plurality of fuel cells 12. The fuel cell system 2 includes a hydrogen supply system 14 and an air supply system 16. The hydrogen supply system 14 supplies a fuel gas containing hydrogen (hereinafter referred to as hydrogen gas) to the fuel cell stack 10. The air supply system 16 supplies oxygen-containing air to the plurality of fuel cells 12. In the fuel cell stack 10, each fuel cell 12 generates electricity by reacting hydrogen supplied from the hydrogen supply system 14 with oxygen in the compressed air supplied from the air supply system 16. The electric power generated by the fuel cell stack 10 is supplied to the battery 40 or the electric load 50 via the step-up converter 20.

The step-up converter 20 is electrically connected to the fuel cell stack 10. The boost converter 20 is configured to boost the output power from the fuel cell stack 10. The specific configuration of the step-up converter 20 is not particularly limited. As an example, the step-up converter 20 may be a non-isolated converter using a switching element and a coil.

The control device 30 controls the operations of the hydrogen supply system 14, the air supply system 16, and the boost converter 20. That is, the control device 30 controls the flow rate and pressure of the hydrogen gas supplied to the fuel cell stack 10 by controlling the operation of the hydrogen supply system 14. Further, the control device 30 controls the flow rate and pressure of the air supplied to the fuel cell stack 10 by controlling the operation of the air supply system 16. The control device 30 is connected to the hydrogen supply system 14, the air supply system 16, and the boost converter 20 via a signal line. The control device 30 is also connected to the fuel cell stack 10 via a signal line, and monitors the temperature of the fuel cell stack 10 and the output voltage (cell voltage) of each fuel cell 12. The control device 30 includes a processor and a memory, and controls operations of the hydrogen supply system 14, the air supply system 16, and the step-up converter 20 by executing various programs stored in the memory by the processor.

The battery 40 is a high-voltage battery. Here, the high voltage means an operating voltage exceeding the DC 60 V. The battery 40 includes a plurality of secondary battery cells and is configured to be chargeable and dischargeable. The secondary battery cell is not particularly limited, but may be, for example, a lithium-ion battery or an all-individual battery.

The electric load 50 is a device driven by electric power supplied from the fuel cell stack 10 or the battery 40. The specific configuration of the electric load 50 is not particularly limited. As an example, the electric load 50 may include an electric motor that drives the wheels and an inverter that controls the power supplied to the electric motor, which is a driving device of the fuel cell electrified vehicle.

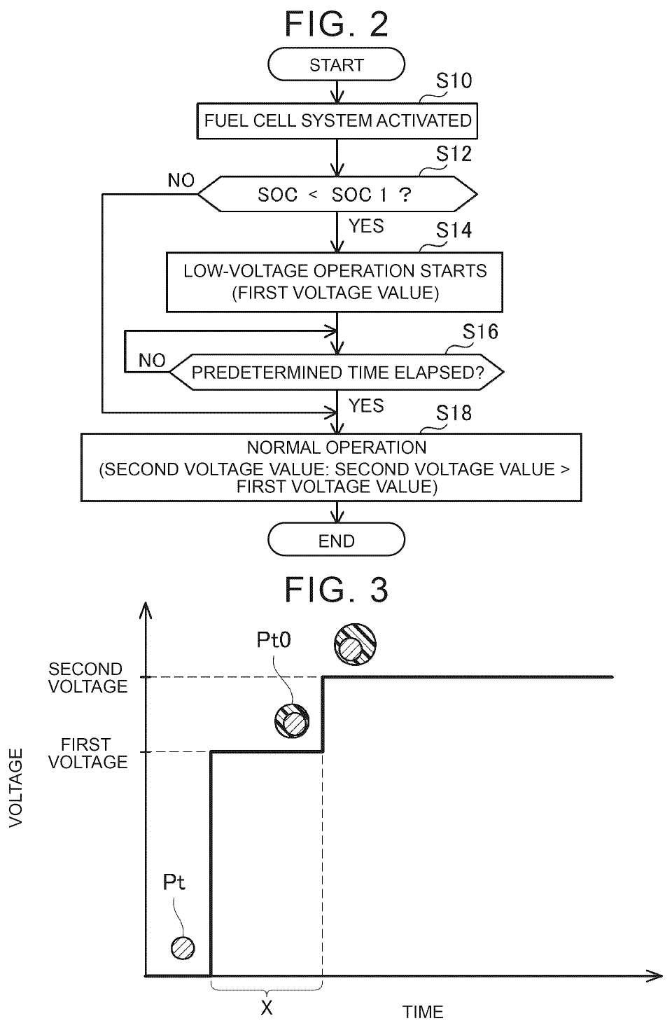

With reference to FIGS. 2 and 3, a series of processes executed by the control device 30 in the fuel cell system 2 of the first embodiment will be described. The control device 30 is configured to start a series of processes shown in FIG. 2 when the fuel cell system 2 is activated. The fuel cell system 2 is activated, for example, in response to an operation by a user. When the fuel cell system 2 is activated (S10), the control device 30 determines whether or not the charge rate (SOC: State of Charge) of the battery 40 is less than the first charge rate (SOC1) (S12). When the charge rate of the battery 40 is less than the first charge rate (SOC<SOC1) (S12: Yes), the control device 30 starts the low-voltage operation (S14). As shown in FIG. 3, in the low-voltage operation (period X in the drawing), the power generation of the fuel cell stack 10 is controlled so that the cell voltage of the fuel cell 12 is maintained at or below the first voltage value. The control device 30 controls the power generation (including the cell voltage) of the fuel cell stack 10 by controlling the operations of the hydrogen supply system 14, the air supply system 16, and the boost converter 20. The electric power generated by the fuel cell stack 10 is charged to the battery 40 via the step-up converter 20. As an example, the first voltage value may be a value such as 600 millivolts, 700 millivolts, or 800 millivolts.

The low-voltage operation is S16 for a predetermined period of time. As an example, the predetermined time period may be a value such as 10 seconds, 15 seconds, 20 seconds, or 60 seconds. When the predetermined period has elapsed (S16: YES), the control device 30 ends the low-voltage operation and shifts to the normal operation (S18). In the normal operation, power generation by the fuel cell stack 10 is controlled so that the cell voltage of the fuel cell 12 is maintained at or above the second voltage value. Here, the second voltage value is higher than the first voltage value. As an example, the second voltage value may be a value such as 800 millivolts, 850 millivolts, or 900 millivolts. After that, when the operation of the fuel cell system 2 is stopped, the series of processing procedures shown in FIG. 2 is ended (end).

On the other hand, in the above-described S12, when the charge rate of the battery 40 exceeds the first charge rate (S12: NO), the control device 30 omits executing the low-voltage operation and starts the normal operation (S18). In low-voltage operation, the current output from the fuel cell stack 10 needs to be relatively large in order to maintain the cell voltage at a relatively low level. As a result, since the charging current supplied to the battery 40 also increases, it is necessary that there is sufficient margin in the charging rate of the battery 40 in order to execute the low-voltage operation. Therefore, when the charging rate of the battery 40 is relatively high, the execution of the low-voltage operation may be omitted, thereby avoiding a situation in which the battery 40 is overcharged.

As described above, the fuel cell system 2 of the present embodiment can perform the low-voltage operation before starting the normal operation. As shown in FIG. 3, in the low-voltage operation (period X in FIG. 3), the power generation of the fuel cell stack 10 is performed while the output voltage (cell voltage) of the fuel cell 12 is maintained at a level lower than the subsequent normal operation. Consequently, in each of the fuel cells 12, an oxide film (PtO) is formed on the surface of the catalyst (Pt). Accordingly, even when the output voltage of the fuel cell 12 is maintained high in the subsequent normal operation, elution and coarsening of the catalyst are suppressed by the oxide film formed on the surface of the catalyst. That is to say, deterioration of the catalyst is suppressed.

### Second Embodiment

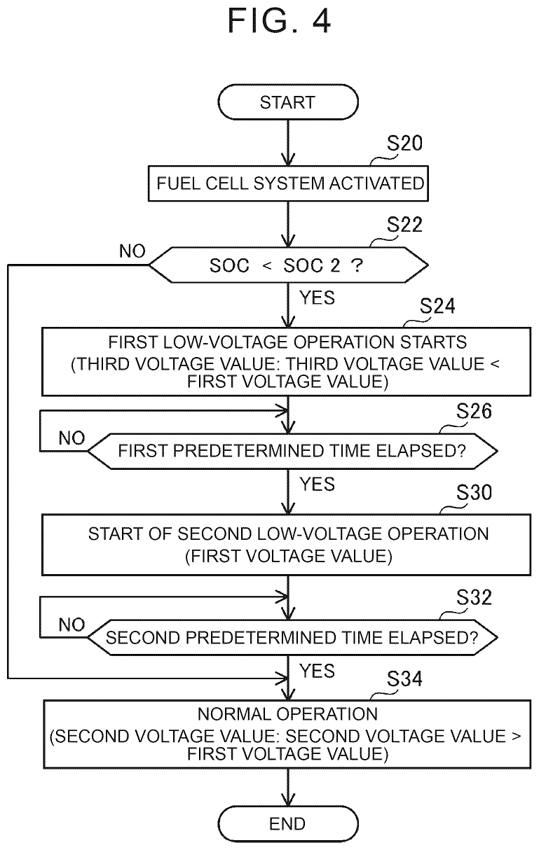

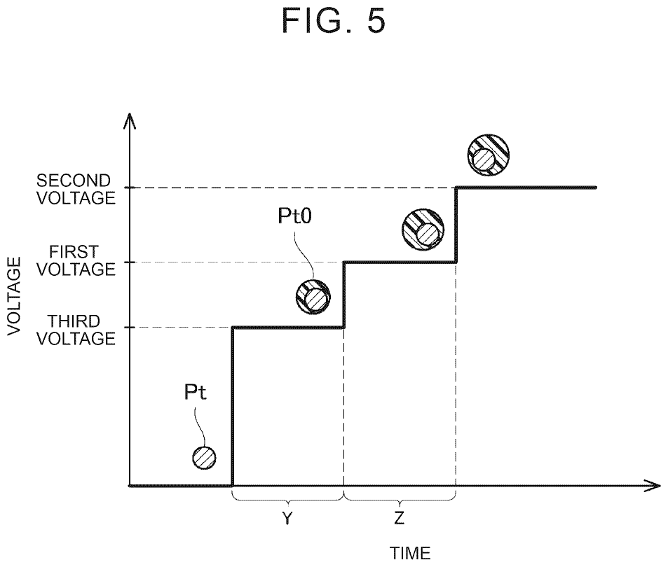

Referring to FIGS. 4 and 5, a fuel cell system according to a second embodiment will be described. In the fuel cell system of the present embodiment, the content of the processing executed by the control device 30 is changed as compared with the fuel cell system 2 of the first embodiment. That is, the control device 30 in the present embodiment is configured to execute a series of processes shown in FIG. 4 instead of the series of processes shown in FIG. 2. Otherwise, the fuel cell system of the present embodiment has the same configuration as the fuel cell system 2 of the first embodiment shown in FIG. 1. That is, the fuel cell system of the present embodiment also includes the fuel cell stack 10, the step-up converter 20, the control device 30, the battery 40, the electric load 50, the hydrogen supply system 14, and the air supply system 16 (see FIG. 1). These configurations and functions are the same as those described in the first embodiment, and redundant description will be avoided here.

Also in the fuel cell system of the present embodiment, the control device 30 is configured to start a series of processes shown in FIG. 4 when the fuel cell system is activated. When the fuel cell system is activated (S20), the control device 30 determines whether or not the charge rate (SOC) of the battery 40 is less than the second charge rate (SOC2) (S22). It is assumed that the second charging rate is lower than the first charging rate described in the first embodiment (i.e., SOC2<SOC1). When the charge rate of the battery 40 is not less than the second charge rate (S22: NO), the control device 30 starts the normal operation (S34) without executing the first low-voltage operation (S24) and the second low-voltage operation (S30) described below. As in the first embodiment, in the normal operation, power generation by the fuel cell stack 10 is controlled so that the output voltage (cell voltage) of the fuel cell 12 is maintained at or above the second voltage value.

On the other hand, when the charge rate of the battery 40 is less than the second charge rate (SOC<SOC2) (S22: YES), the control device 30 starts the first low-voltage operation (S24). As shown in FIG. 5, in the first low-voltage operation (period Y in the drawing), the power generation of the fuel cell stack 10 is controlled so that the cell voltage of the fuel cell 12 is maintained at or below the third voltage value. Although not particularly limited, the third voltage value is a value lower than the first voltage value described in Example 1 (that is, the third voltage value<the first voltage value). As an example, the third voltage value may be a value such as 500 millivolts, 600 millivolts, or 700 millivolts.

The first low-voltage operation is S26 for a first predetermined period of time. As an example, the first predetermined time period may be a value of 10 seconds, 15 seconds, 20 seconds, 60 seconds, or 90 seconds. When the first predetermined period has elapsed (S26: YES), the control device 30 ends the first low-voltage operation and shifts to the second low-voltage operation (S30). As shown in FIG. 5, in the second low-voltage operation (period Z in the drawing), power generation by the fuel cell stack 10 is controlled so that the cell voltage of the fuel cell 12 is maintained at the first voltage value or higher. As described above, the first voltage value may be a value such as 800 millivolts, 850 millivolts, or 900 millivolts.

The second low-voltage operation is S32 for a second predetermined period of time. As an example, the second predetermined time period may be a value of 10 seconds, 15 seconds, 20 seconds, 60 seconds, or 90 seconds. When the second predetermined period has elapsed (S32: YES), the control device 30 ends the second low-voltage operation and shifts to the normal operation (S34). In the normal operation, power generation by the fuel cell stack 10 is controlled so that the cell voltage of the fuel cell 12 is maintained at or above the second voltage value. As described above, the second voltage value is higher than the first voltage value. The second voltage value may be a value such as 800 millivolts, 850 millivolts, or 900 millivolts. After that, when the operation of the fuel cell system 2 is stopped, the series of processing procedures shown in FIG. 4 is ended (end).

As described above, the fuel cell system of the second embodiment can perform the first low-voltage operation and the second low-voltage operation before starting the normal operation. As shown in FIG. 5, in the first low-voltage operation (period Y) and the second low-voltage operation (period Z), the power generation of the fuel cell stack 10 is performed while the cell voltage of the fuel cell 12 is maintained at a level lower than the subsequent normal operation. In addition, in their series of low-voltage operations (periods Y and Z), the cell voltage is changed in two steps. In particular, in the first low-voltage operation in the previous period, by keeping the cell voltage lower, the oxidation reaction of the catalyst (Pt) is activated, it is possible to promote the generation of an oxide film (PtO). In the second low-voltage operation in the later stage, the cell voltage is increased, so that the oxide film (PtO) can be further grown while the power generated by the fuel cell stack 10 is suppressed. Accordingly, even when the cell voltage of the fuel cell 12 is maintained high in the subsequent normal operation, elution and coarsening of the catalyst are suppressed by the oxide film formed on the surface of the catalyst. In addition, the load on the battery 40 can be reduced by increasing the cell voltage and decreasing the power generated by the fuel cell stack 10.

### Third embodiment

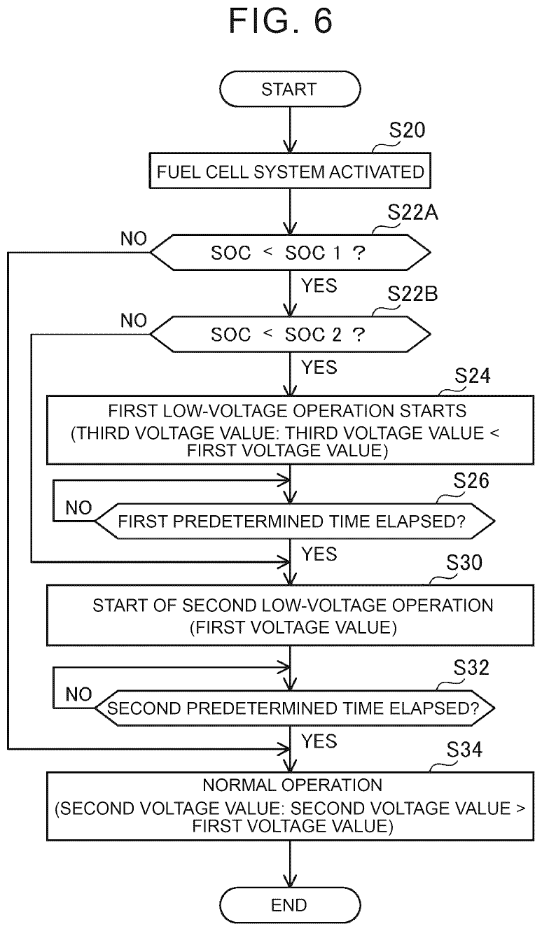

Referring to FIG. 6, a fuel cell system according to a third embodiment will be described. In the fuel cell system of the present embodiment, the content of the processing executed by the control device 30 is changed as compared with the fuel cell system 2 of the first embodiment. That is, the control device 30 in the present embodiment is configured to execute a series of processes shown in FIG. 6 instead of the series of processes shown in FIG. 2. Otherwise, the fuel cell system of the present embodiment has the same configuration as the fuel cell system 2 of the first embodiment shown in FIG. 1. That is, the fuel cell system of the present embodiment also includes the fuel cell stack 10, the step-up converter 20, the control device 30, the battery 40, the electric load 50, the hydrogen supply system 14, and the air supply system 16 (see FIG. 1). These configurations and functions are the same as those described in the first embodiment, and redundant description will be avoided here.

Also in the fuel cell system of the present embodiment, the control device 30 starts a series of processes shown in FIG. 6 when the fuel cell system is activated. In the series of processes shown in FIG. 6, the process (S22; S22A, S22B) of determining the charge rate of the battery 40 is changed as compared with the series of processes of the second embodiment shown in FIG. 4. When the fuel cell system is activated (S20), the control device 30 first determines whether or not the charge rate (SOC) of the battery 40 is less than the first charge rate (SOC1) (S22A). When the charge rate of the battery 40 is not less than the first charge rate (S22A: NO), the control device 30 starts the normal operation (S34) without executing the first low-voltage operation (S24) and the second low-voltage operation (S30).

When the charge rate of the battery 40 is less than the first charge rate (SOC<SOC1) (S22A: YES), the control device 30 further determines whether the charge rate of the battery 40 is less than the second charge rate (SOC2) (S22B). As described above, the second charge rate is lower than the first charge rate (i.e., SOC2<SOC1). When the charge rate of the battery 40 is less than the second charge rate (SOC<SOC2) (S22B: YES), the control device 30 executes the first low-voltage operation (S24) and the second low-voltage operation (S30) in that order. On the other hand, when the charge rate of the battery 40 is not less than the second charge rate (S22B: NO), the control device 30 omits the execution of the first low-voltage operation (S24) and executes only the second low-voltage operation (S30). The first low-voltage operation and the second low-voltage operation are the same as those described in the second embodiment, and therefore, redundant description will be omitted here. Thereafter, the control device 30 shifts to the normal operation (S34).

As described above, the fuel cell system of the third embodiment can perform both the first and second low-voltage operations or only the second low-voltage operation according to the charging rate of the battery 40. That is, the low-voltage operation can be performed in an appropriate manner according to the charging rate of the battery 40. As an example, the control device 30 may shift to the second low-voltage operation when the charging rate of the battery 40 reaches the first charging rate after the start of the first low-voltage operation. According to such a configuration, when the charging rate of the battery 40 is higher than expected after the start of the first low-voltage operation, the first low-voltage operation can be stopped at that time and the operation can be shifted to the second low-voltage operation. The low-voltage operation can be performed in an appropriate manner depending on the charging rate of the battery 40 while preventing the battery 40 from being overcharged.

While specific examples of the technology disclosed in the present specification have been described in detail above, these examples are merely illustrative and do not limit the scope of the claims. The technique described in the claims includes various modifications and variations of the specific examples exemplified above. The technical elements described in this specification or in the drawings may be used alone or in various combinations, and are not limited to the combinations described in the claims at the time of filing. In addition, the technique exemplified in the present specification or drawings can achieve a plurality of purposes at the same time, and achieving one of the purposes itself has technical usefulness.

What is claimed is:

1. A fuel cell system comprising:
a fuel cell stack in which a plurality of fuel cells is disposed, being stacked;
a battery that is electrically connected to the fuel cell stack and that performs charging of power generated by the fuel cell stack; and
a control device for controlling power generation by the fuel cell stack, wherein
the control device is configured to execute a low-voltage operation prior to transition to a normal operation, when the fuel cell system is activated,
in the low-voltage operation, power generation by the fuel cell stack is controlled such that output voltage of the fuel cells is maintained at no higher than a first voltage value, and
in the normal operation, power generation by the fuel cell stack is controlled such that the output voltage of the fuel cells is maintained at no lower than a second voltage value that is higher than the first voltage value.

2. The fuel cell system according to claim 1, wherein, when the fuel cell system is activated and a charging rate of the battery exceeds a first charging rate, the control device skips execution of the low-voltage operation.

3. The fuel cell system according to claim 2, wherein the low-voltage operation includes
a first low-voltage operation in which power generation by the fuel cell stack is controlled such that the output voltage of the fuel cells is maintained at no higher than a third voltage value that is lower than the first voltage value, and
a second low-voltage operation in which power generation by the fuel cell stack is controlled such that the output voltage of the fuel cells is maintained between the third voltage value and the first voltage value.

4. The fuel cell system according to claim 3, wherein when the fuel cell system is activated, the control device
executes the first low-voltage operation and the second low-voltage operation in that order when the charging rate of the battery is lower than a second charging rate that is lower than the first charging rate, and
skips execution of the first low-voltage operation and executes the second low-voltage operation when the charging rate of the battery is between the second charging rate and the first charging rate.

5. The fuel cell system according to claim 3, wherein, when the charging rate of the battery reaches the first charging rate after starting of the first low-voltage operation, the control device transitions to the second low-voltage operation.
